(19) United States
(12) Patent Application Publication
(10) Pub. No.: US 2014/0019337 A1
(43) Pub. Date: Jan. 16, 2014

(54) CREDITOR OFFERS FOR TAKING A USER DEBT

(71) Applicants: Darrell Esch, San Jose, CA (US); Michael We Chung Wu, Mountain View, CA (US)

(72) Inventors: Darrell Esch, San Jose, CA (US); Michael We Chung Wu, Mountain View, CA (US)

(73) Assignee: EBAY, INC., San Jose, CA (US)

(21) Appl. No.: 13/549,159

(22) Filed: Jul. 13, 2012

(51) Int. Cl. G06Q 20/22

(52) U.S. Cl. 705/39

(57) ABSTRACT

Once a user has made a purchase (or during a checkout), a service provider may offer one or more creditors to the user to fund a payment on behalf of the user. The service provider may offer this service to one or more creditors in an auction or bid scenario, in which creditors may submit bids to “win” this service. The winning creditor(s) or payment provider(s) may be featured or displayed to the user when the user is deciding how to make a payment. In this way, a user is more likely to either sign up with a creditor and use the creditor to make a payment or use an already-existing account with the creditor to make a payment.

### BACKGROUND

1. Field of the Invention

The present invention generally relates to user debt and more particularly to creditors taking a user debt.

2. Related Art

Consumers have many options for making a payment or purchase beyond traditional cash. For example, consumers may make a purchase using credit, which allows a creditor to make the payment on behalf of the consumer, but then obligates the consumer to pay back the creditor at a later date. Creditors and payment providers, such as credit card companies and banks, want such consumers to use their products, which can generate income and other benefits for the creditors, such as interest payments, finance charges, fees, etc.

Creditors market or solicit potential new customers in a variety of ways, such as television ads, print ads, and Internet ads extolling various advantages, such as low interest rates on outstanding account balances, free checking, high interest rates on account balances, zero interest rate for a period of time, free gifts, and the like.

Once a customer is acquired, the creditors want the customer to use the services of the creditors as much as possible to increase customer loyalty and creditor revenues.

Because customer acquisition and credit use is so important to creditors and other payment providers, it would be desirable to have additional ways to acquire new customers and promote creditor product use.

### SUMMARY

According to one embodiment, once a user has made a purchase, a service provider may offer one or more creditors to the user to fund a payment on behalf of the user. The service provider may offer this service to one or more creditors in an auction or bid scenario, in which creditors may submit bids to “win” this service. The winning creditor(s) or payment provider(s) may be featured or displayed to the user when the user is deciding how to make a payment. In this way, a user is more likely to either sign up with a creditor and use the creditor to make a payment or use an already-existing account with the creditor to make a payment.

In one embodiment, a user makes a purchase through a service provider, such as PayPal, Inc. of San Jose, Calif. The purchase may be made online, through the user's mobile device, at a point of sale, or other means. When ready to make the purchase with a merchant or seller, the user selects the service provider, which processes the payment to the merchant on behalf of the user. Typically, the service provider makes the payment to the merchant and then debits an appropriate amount from the user's account with the payment provider. The user's account may be funded by a user bank account, credit card, or other funding source. The selected funding source is typically charged to fund the user's account at the time of the payment or transaction.

The service provider may offer the user of option of deferring payment for a certain period of time after the purchase. For example, the service provider may still make a payment to the merchant after the transaction, but would not charge against the user's funding source until a later date. During this period, the user is able to change a funding source or other payment options. If the user does not change anything, the originally selected funding source is used.

According to one embodiment, the user may access the user's account with the payment provider or otherwise be notified that a payment is due for the recent purchase. The user may see or otherwise be notified of one or more creditors the user can select for making the payment or as the funding source for the transaction. For example, the user may see a button or link that indicates “Pay with a Chase Card.” By selecting the button, the Chase card can be selected as the funding source for the transaction if the user's Chase card was already linked to the user service provider account or the Chase card can be linked to the user account and then added as the funding source for the transaction.

If the user does not have an account or is not a customer of the offered creditor, in this case, Chase, the user may still select the button to initiate a process to open an account with Chase. Once opened, the Chase card or account is automatically used as the funding source for the transaction.

As a result, the offered creditor receives the benefit of a user utilizing the creditor account, as well as possibly obtaining a new customer.

The service provider may selectively choose which creditor(s) to offer to a user for a specific transaction, such as based on value for or business relationships with a specific creditor. The service provider may also offer up for bid this service for a particular user or transaction. Multiple creditors may see this offer and bid for this service, with the highest or most attractive bid winning the service and having its product offered to the user for paying off a debt for the transaction.

To further entice the user to select an offered creditor, the service provider and/or the creditor may offer incentives to the user for selecting the creditor to fund or pay for the transaction. For example, the user may be provided a reduced interest rate on outstanding balance, a gift certificate, a coupon, etc.

As a result, the user may also benefit from such a service.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process for providing a user one or more creditors for funding a purchase according to one embodiment;

FIG. 2 is a flowchart showing a process for selecting one or more creditors to offer a user for funding a purchase according one embodiment;

FIG. 3 is block diagram of a networked system suitable for implementing the process described herein according to an embodiment; and

FIG. 4 is a block diagram of a computer system suitable for implementing one or more components in FIG. 3 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

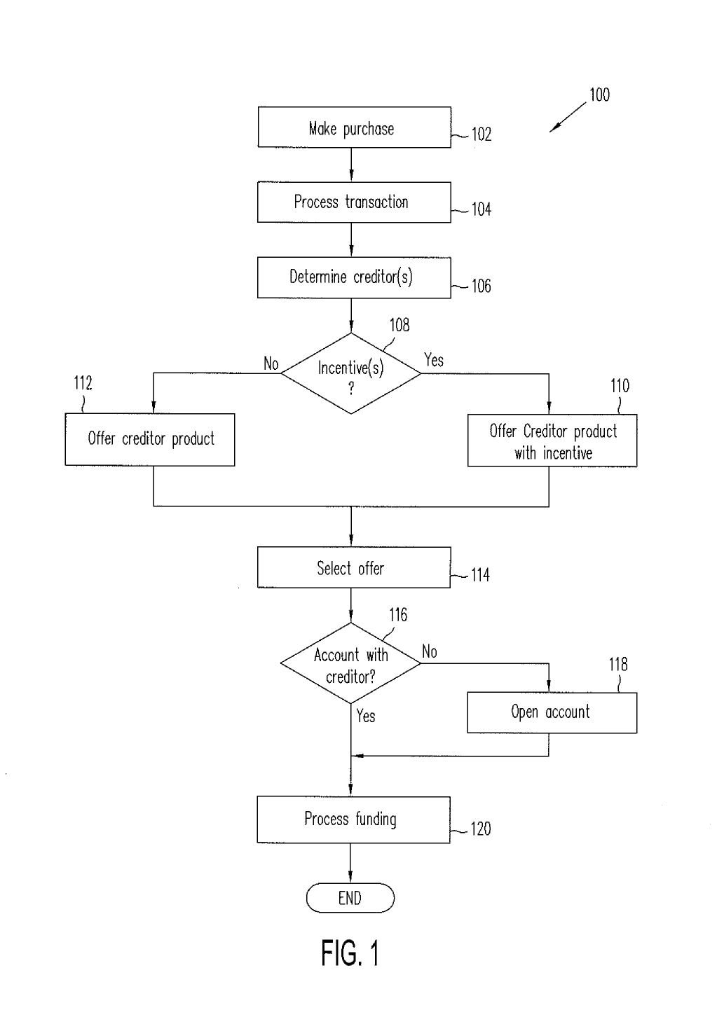

FIG. 1 is a flowchart showing a process 100 for providing a user one or more creditors for funding a purchase according to one embodiment. At step 102, the user makes a purchase or payment using a user account with a service or payment provider, such as PayPal, Inc. of San Jose, Calif. The purchase can be at a physical point of sale, such as at a merchant location, online through a user's PC or other computing device, or through a mobile app on the user's mobile device. The purchase may be physical or digital goods. “Purchase” as used herein may also denote payment to another or an entity, such as a charitable donation.

At step 104, the transaction or purchase is processed by the payment provider. This may include determining whether to approve or deny the purchase, such as based on user account restrictions, fraud analysis, and one or more funding sources previously selected by the user to fund purchases made through the user account with the payment provider. Funding sources may include one or more bank accounts, one or more debit cards, or one or more credit cards. If the purchase is approved, the payment provider may credit an account of the merchant or payee and debit an account of the payment provider or the user account with the payment provider.

In this embodiment, the purchase is processed based on the funding sources previously selected or selected during the current transaction and the user having the ability to pay for the transaction after purchase. Details of such a feature are described in commonly-owned U.S. patent application Ser. No. 13/336,929, filed Dec. 23, 2011, which is incorporated by reference herein in its entirety. The payment provider makes the payment for the purchase to the merchant, but does not yet charge against the user's funding source(s). The user is given a certain period of time, e.g., five days, from the transaction to change a funding source if desired. The user may choose a funding option for various reasons, such as available balance, available credit, billing cycle for the credit card, rewards for a specific credit card use, etc.

Once the transaction is completed, the payment provider may determine, at step 106, one or more suitable creditors for the user to choose from for funding the user account or purchase. Examples of creditors include different banks, different credit card companies, and different third party payment services providers. The creditors need to be ones that are acceptable to the payment provider and available for the user (either as a current customer or eligible to become a customer of the creditor). For example, a creditor may be a bank in Mexico, but the user, who resides in the United States, may not be able to open or have an account with the bank. A determination of suitable creditors may also depend on the user and/or the transaction, such as dollar amount. For example, certain creditors may not be available to the user for this transaction.

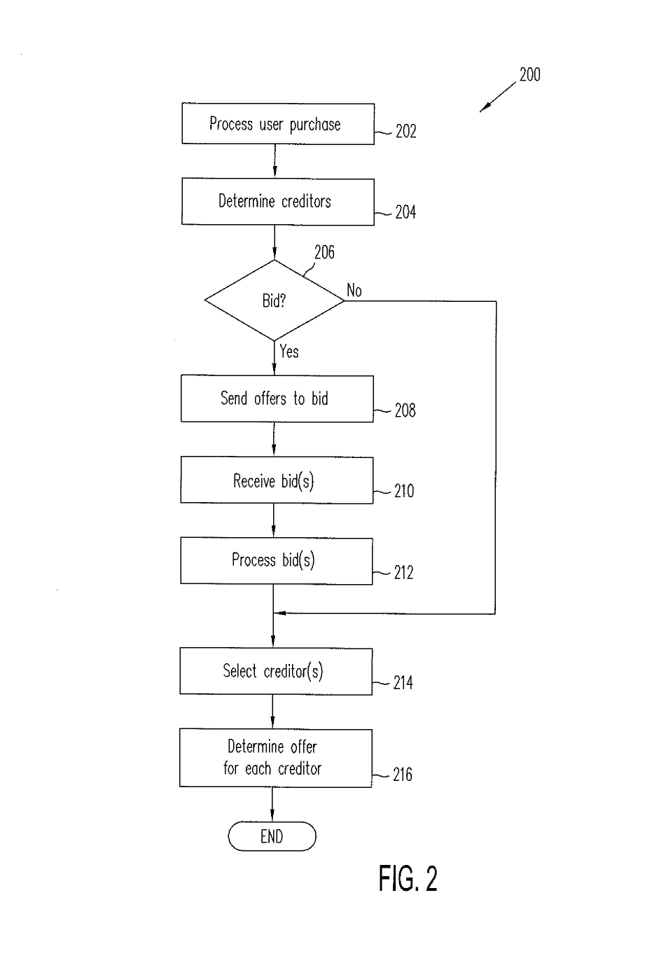

After suitable or available creditors are determined, the system further determines which one or ones of the available creditors to offer to the user. Typically, only one creditor is offered; however, there may be cases where more than one is offered to the user. The payment provider may offer credit products from a creditor or multiple creditors who have submitted the highest or best bids in exchange for the payment provider offering the credit product(s) to the user. Additional details of determining suitable creditors to present to the user are provided in FIG. 2 and corresponding text.

Once available creditors are determined, the system determines, at step 108, whether there are any incentives that can be offered with each creditor or creditor product and may depend on whether is a current customer of the creditor. The incentives would be offered to incentive the user to select the corresponding creditor for funding the purchase. For example, incentives may be greater for users having no current relationship with the creditor or for users who are infrequent users of the products offered by the creditor. Incentives may be provided by the creditor and/or the payment provider. Examples include monetary credits, gift cards, gifts, temporary low interest rate on balances, free or discounted products, services, or fees, coupons, or other types of incentives.

If there are one or more incentives to offer, by the payment provider and/or the creditor, such an offer is made to the user at step 110. For example, the user may see a button or link on a page of the user's account with the payment provider, notifying the user that an eligible purchase may be made with a particular creditor or product. The button or link may be associated with information about one or more incentives the user can receive for selecting the creditor to fund the purchase. This may be shown with the button or link or as a pop-up when the user rolls over the button or link or otherwise selects the button or link. For example, the user may see a button that says “Pay with Chase and receive a free gift” or a pop-up message that says “Receive a free gift if you pay with Chase” when the user rolls over the “Pay with Chase” button.

If, as determined at step 108, the selected creditor(s) do not have incentives associated with them, the user will be offered the particular creditor or product without any incentives associated with it. For example, the user may simply see a button that says “Pay with Chase”.

In addition to or alternatively from the user seeing the creditor product on the payment provider site, the user may receive a text, voice, or email notification containing the same or similar information. For example, the user may receive the notification on a user mobile device when the user is required to or eligible to make a funding source selection, such as within the predetermined pay-after-purchase period.

Note that if no pay-after-purchase option is offered or available, the creditor offer(s) may be presented to the user during checkout or payment of the transaction or purchase. For example, after the user is ready to checkout and is ready to select a payment or funding source, the user may be presented with one or more creditor offerings or products, such as one or more buttons, links, or lists. This may be in addition to the user's normal payment provider account.

Regardless of whether the creditor products are offered during checkout or afterwards in a pay-after-purchase scenario, the user may select, at step 114, an offered creditor or product, such as by tapping, clicking on, or otherwise selecting a button, link, or other indicator of the offer. Information, such as the user's desire or interest in using the creditor/product, any incentives offered, transaction information, merchant information, and/or user information, is then communicated electronically to the payment provider or other entity.

At step 116, a determination is made whether the user has a relationship or account with the selected creditor. If the user has no account or active account, the user may be asked to open an account to use the selected creditor. An account may be opened, at step 118, by providing requested information to the payment provider and/or the creditor. For example, the user may be asked to provide, through the user device, a name, user name, password, PIN, email address, phone number, mailing address, a bank account or credit card number, a date of birth, a social security number, and/or other information as needed. Certain fields may be auto-filled if information is available from the payment provider.

The funding may be processed at step 120 once the account is opened or if the user already has a valid account with the selected creditor. In the latter case, the user may be asked for authentication information with the payment provider, if not already logged in, such as a user identifier (name, email address, user name, phone number) and a password or PIN. Processing may include the payment provider charging an amount against the user selected creditor account for the associated purchase and crediting an account of the user with the payment provider or an account of the payment provider in a pay-after-purchase transaction. If the selected creditor is selected during a checkout process for the current transaction, the payment provider may also credit an account of the merchant or seller. The creditor may have an account with the payment provider so that the payment provider may debit an account of the creditor with the appropriate amount for the payment.

FIG. 2 is a flowchart showing a process 200 for selecting one or more creditors to offer a user for funding a purchase according one embodiment. At step 202, the payment provider processes the user purchase. This may be after the transaction is completed (in a pay-after-purchase case) or after the user is ready to pay during a current transaction (in a checkout flow before payment is confirmed). This step may be similar to step 104 in FIG. 1 in one embodiment. At step 204, the payment provider determines creditors available to the user for funding the purchase, such as described at step 106 in FIG. 1. For example, all creditors available to the user and available to offer by the payment provider may be determined, such as based on user location, transaction amount, and any other details. Alternatively, only a portion of such creditors may be initially determined, such as the top five who are preferred partners with the payment provider or the lowest five who are partners with the payment provider. The latter group may allow the payment provider to improve the relationship with those partners by offering them this service, while the former group may be rewarded for their preferred status.

The payment provider may determine, at step 206, whether a bid or offer is to be sent to one or more of the creditors determined at step 204. Because the service offered by the payment provider is valuable to creditors, creditors may be asked to bid or provide other benefits to the payment provider in exchange for the payment provider offering a creditor product to the user. The creditor may not have access to the user and/or the user may be someone who rarely uses the creditor's product. As such, this provides the creditor an unique opportunity to increase usage of is services.

If a decision to bid out the service is made, the payment provider may send out offers to bid at step 208 to one or more of the creditors determined at step 204. The offers to bid may be sent simultaneously to the creditors via a creditor device, such as a server or computer through an email or other means. The offer may include details of the offer, such as transaction information, user information, and bidding instructions. Bidding instructions may include a “buy it now” price, a starting bid price, only allowing a single blind bid from each creditor, allowing multiple bids from single creditors, exposing bids to other creditors, and/or an end time for bidding. For example, in a “pay-after-purchase” transaction, the end time may be the time that the user needs to decide whether to change a funding source or default to an earlier selected funding source. In another example, the bidding instructions may not be for monetary bids, but for other value, such as discounts or other incentives provided to the payment provider for use or for the payment provider to offer its customers. In different embodiments, the bidding may be for the single transaction, multiple transactions with the user, and/or multiple transactions with the merchant.

Bids from interested creditors are then received, at step 210, and processed, by the payment provider at step 212. Processing may include determining which bids were received within a time period (if specified) and which bids comply with any other requirements of the bidding process. Processing would then include considering only those bids that meet the bidding submission requirements. In one embodiment, the payment provider assigns scores or other quantitative indicators to each bid, with the highest (or lowest) scores indicating the most desirable bids. Note that a top bid may not necessarily be the one with the highest dollar amount. For example, a creditor having a slightly lower dollar amount bid may still have a better bid score if the creditor is also a preferred partner and/or the creditor is also offering other value, such as incentives to the payment provider.

Once the bids have been processed, the payment provider selects, at step 214, one or more creditors to offer to the user. The payment provider may select only one creditor or multiple creditors, with the number being disclosed to bidders with the bidding instructions. The selection may be based, partly or completely, on the highest (or lowest) bid scores or other selection criteria. With multiple creditors selected, the payment provider may treat all equally, e.g., give each creditor equal placement, visibility, or presentation for the user, or differently, e.g., give one creditor a better placement, visibility, and/or presentation for the user relative to one or more of the other selected creditors, such as placing that creditor at a top of a list, making the creditor offer larger, brighter, and/or of a different color.

Referring back to step 206, if the payment provider decides not to offer out for bid on a user purchase, the payment provider may select, at step 214, one or more of creditors from step 204 based on criteria other than bids. For example, creditor(s) may be selected based on a preference or preferred level with the payment provider, which can be based on fees paid to the payment provider or other factors. The selection may be based on the user, user purchase, or other information that would result in one creditor being better suited for the user than other creditors for this particular transaction. Selection may also be based on any prepaid plans or agreements between a creditor and the payment provider. For example, a creditor may have purchased a plan that gives it a certain number of offers to users, for certain dollar amount purchases, etc. The creditor may have an agreement that the payment provider only provide creditor offers for those users who are not current customers of the creditor, but have previously been customers and/or other types of conditions.

Selection of creditors may use one or more the different factors discussed herein regardless of whether a user transaction was offered for bid.

Once the creditor(s) have been chosen or determined, the payment provider determines which offer to associate with each selected creditor at step 216. Again, this may be based on an agreement between the creditor and the payment provider, which may set out one or more offers for one or more different categories or conditions. Different categories or conditions may include whether the user is a current customer, a prior customer, never been a customer of the creditor, a current customer who rarely uses the creditor's product, the amount of the transaction, the type of transaction or purchase, the merchant name or type, the location of the user and/or purchase, risk or credit-worthiness of the user (such as determined by the payment provider and/or one or more credit reporting agencies), the time of year (e.g., holiday season), how many funding sources the user has with the payment provider, how many credit cards the user has overall, etc.

For example, a creditor may offer a 0% interest on fund transfers for a period of four months for a user with good credit, makes a lot of purchases, and has made a high dollar purchase with the current transaction. In another example, the a creditor may offer the user no annual fee with a card to a user who has several credit cards and makes many purchases. In yet another example, a creditor may provide additional points on purchases for an airline if the user has just purchased airline tickets in the current transaction. In one situation, a creditor may offer to provide a current (but infrequent) customer of the creditor a 6-month period of no interest on purchases made during the next 6 months. A further example is an offer for a $10 gift certificate at Barnes and Nobles™ if the user purchased several books in the current transaction. Thus, offers or incentives for a user to open an account with a creditor or use the creditor to pay off a purchase may be provided directly by the creditor, through partners or other merchants, or through third party services, such as the payment provider.

Thus, incentives provided to the user for using the offered funding source may be customized. The incentives may be general, semi-customized, or customized for the user. Semi-customized and customized incentives may be based on the amount of the current purchase/payment, the history, if any, of the user with the funding source, such as how long the user has been a customer of the funding source, the balances carried by the user with the funding source, etc., purchase history of the user, such as amount spent, number of purchases, and other factors discussed herein.

The creditor offer does not have to have incentives. The offer may simply be for the user to pay off the purchase with the specific creditor. Regardless, the offer (and any details or incentives) may be presented to user through a button or link so that the user can simply select the button or link to use the credit product or get more information about any incentives. The user may select the link or button to begin a sign-up with the creditor if the user is not a current customer of the creditor.

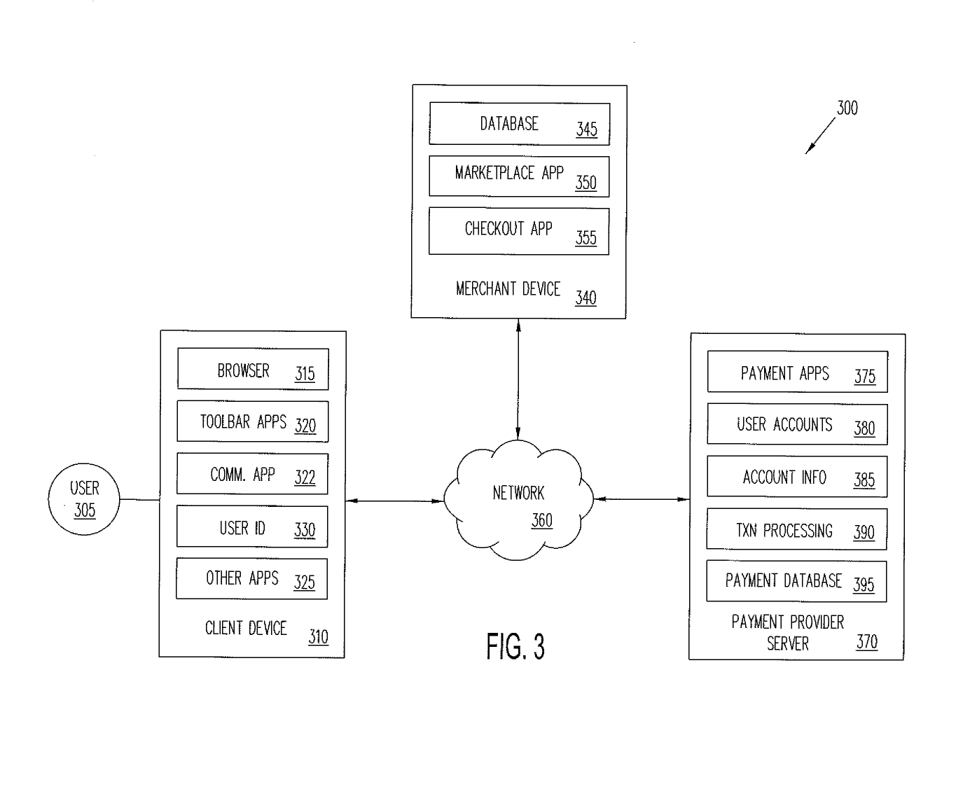

FIG. 3 is a block diagram of a networked system 300 configured to handle a transaction using a smart wallet, such as described above, in accordance with an embodiment of the invention. System 300 includes a user device 310, a merchant server 340, and a payment provider server 370 in communication over a network 360. Payment provider server 370 may be maintained by a payment provider, such as PayPal, Inc. of San Jose, Calif. A user 305, such as a sender or consumer, utilizes user device 310 to perform a transaction using payment provider server 370. Note that transaction, as used herein, refers to any suitable action performed using the user device, including payments, transfer of information, display of information, etc. Although only one merchant server is shown, a plurality of merchant servers may be utilized if the user is purchasing gifts from multiple merchants.

User device 310, merchant server 340, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™

User device 310 may include one or more browser applications 315 which may be used, for example, to provide a convenient interface to permit user 305 to browse information available over network 360. For example, in one embodiment, browser application 315 may be implemented as a web browser configured to view information available over the Internet, such as a user account for setting up a gift list and/or merchant sites for viewing and purchasing gifts. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive emails, calls, and texts through network 360, as well as applications that enable the user to communicate, transfer information, make payments, and otherwise utilize a smart wallet through the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300.

Merchant server 340 may be maintained, for example, by a merchant or seller offering various products and/or services in exchange for payment to be received over network 360. Merchant server 340 may be used for POS or online purchases and transactions. Generally, merchant server 340 may be maintained by anyone or any entity that receives money, which includes charities as well as retailers and restaurants. For example, a recommended gift may be a donation to charity in the name of the recipient. Merchant server 340 includes a database 345 identifying available products and/or services (e.g., collectively referred to as items) which may be made available for viewing and purchase by user 305. Accordingly, merchant server 340 also includes a marketplace application 350 which may be configured to serve information over network 360 to browser 315 of user device 310. In one embodiment, user 305 may interact with marketplace application 350 through browser applications over network 360 in order to view various products, food items, or services identified in database 345.

Merchant server 340 also includes a checkout application 355 which may be configured to facilitate the purchase by user 305 of goods or services identified by marketplace application 350. Checkout application 355 may be configured to accept payment information from or on behalf of user 305 through payment service provider server 370 over network 360. For example, checkout application 355 may receive and process a payment confirmation from payment service provider server 370, as well as transmit transaction information to the payment provider and receive information from the payment provider (e.g., a transaction ID).

Payment provider server 370 may be maintained, for example, by an online payment service provider which may provide payment between user 305 and the operator of merchant server 340. In this regard, payment provider server 370 includes one or more payment applications 375 which may be configured to interact with user device 310 and/or merchant server 340 over network 360 to facilitate the purchase of goods or services, communicate/display information, and send payments by user 305 of user device 310 and as discussed above.

Payment provider server 370 also maintains a plurality of user accounts 380, each of which may include account information 385 associated with consumers, merchants, and funding sources, such as credit card companies. For example, account information 385 may include private financial information of users of devices such as account numbers, passwords, device identifiers, user names, phone numbers, credit card information, bank information, or other financial information which may be used to facilitate online transactions by user 305. Account information may also include user purchase history and user ratings. Offers and/or incentives from creditors may also be stored with account information 385, as well as bids submitted by a creditor for the payment provider offering a product of the creditor. Advantageously, payment application 375 may be configured to interact with merchant server 340 on behalf of user 305 during a transaction with checkout application 355 to track and manage purchases made by users and which and when funding sources are used.

A transaction processing application 390, which may be part of payment application 375 or separate, may be configured to receive information from a user device and/or merchant server 340 for processing and storage in a payment database 395. Transaction processing application 390 may include one or more applications to process information from user 305 for processing an order and payment using various selected funding instruments, including for initial purchase and payment after purchase as described herein. As such, transaction processing application 390 may store details of an order from individual users, including funding source used, credit options available, etc. Payment application 375 may be further configured to determine the existence of and to manage accounts for user 305, as well as create new accounts if necessary, such as the set up and management payments by the user after the initial purchase (e.g., pay after purchase) as discussed herein.

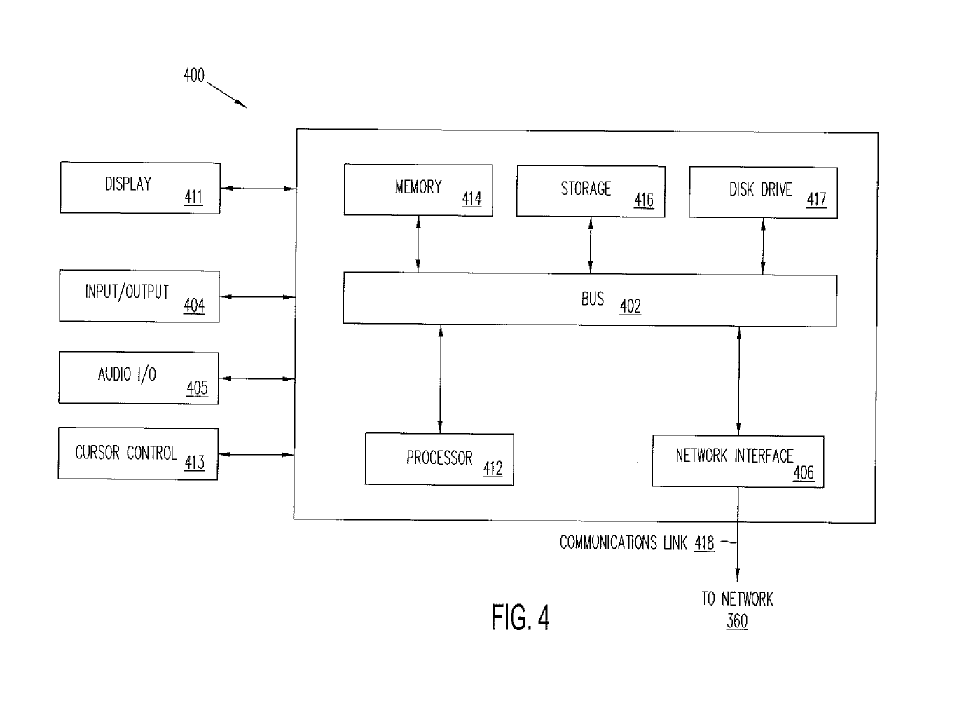

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system for facilitating a financial transaction over a network, comprising:
a memory storing user account information, wherein the information comprises user purchase history with a payment provider entity; and
one or more processors in communication with the memory adapted to:
receive, by a computer of the payment provider entity, a payment request from a user for using services of the payment provider entity to make a payment;
receive bids from a plurality of creditors to have the payment provider entity provide an offer to the user to use a specific creditor for funding the payment on behalf of the user;
determine, based at least on the bids, one or more creditors from the plurality of creditors to present to the user;
offer the user the one or more creditors as user-selectable options for funding the payment; and
process the payment using a selected one of the one or more creditors.

2. The system of claim 1, wherein the offering is after the payment has been made by the payment provider entity to a payee.

3. The system of claim 2, wherein the offering is made before a time period expires after the payment was made by the payment provider entity to the payee.

4. (canceled)

5. The system of claim 1, wherein the one or more processors further determines a ranking for the plurality of creditors who submitted bids.

6. The system of claim 1, wherein the offering comprises at least one incentive for using a creditor for the payment.

7. The system of claim 1, wherein at least one of the plurality of creditors does not have an account with the user.

8. The system of claim 1, wherein at least one of the plurality of creditors has an account with the user.

9. The system of claim 1, wherein the offering is based, at least in part, on the financial transaction.

10. A non-transitory machine-readable medium comprising a plurality of machine-readable instructions which when executed by one or more processors of a server are adapted to cause the server to perform a method comprising:
receiving, by a computer of a payment provider entity, a payment request from a user for using services of the payment provider entity to make a payment for a financial transaction;
receiving bids from a plurality of creditors to have the payment provider entity provide an offer to the user to use a specific creditor for funding the payment on behalf of the user;
determining, based at least on the bids, one or more creditors from the plurality of creditors to present to the user;
offering the user the one or more creditors as user-selectable options for funding the payment; and
processing the payment using a selected one of the one or more creditors.

11. The non-transitory machine-readable medium of claim 10, wherein the offering is after the payment has been made by the payment provider entity to a payee.

12. The non-transitory machine-readable medium of claim 11, wherein the offering is made before a time period expires after the payment was made by the payment provider entity to the payee.

13. (canceled)

14. The non-transitory machine-readable medium of claim 10, wherein the method further comprises determining a ranking for the plurality of creditors who submitted bids.

15. The non-transitory machine-readable medium of claim 10, wherein the offering comprises at least one incentive for using a creditor for the payment.

16. The non-transitory machine-readable medium of claim 10, wherein the offering is based, at least in part, on the financial transaction.

17. A method, comprising:
receiving, electronically by a hardware processor of a payment provider entity, a payment request from a user for using services of the payment provider entity to make a payment;
receiving bids from a plurality of creditors to have the payment provider entity provide an offer to the user to use a specific creditor for funding the payment on behalf of the user;
determining, based at least on the bids, one or more creditors from the plurality of creditors to present to the user;
offering the user, electronically on a user device, the one or more creditors as user-selectable options for funding the payment; and
processing the payment using a selected one of the one or more creditors.

18. The method of claim 17, wherein the offering is after the payment has been made by the payment provider entity to a payee.

19. The method of claim 17, wherein the offering is made before a time period expires after the payment was made by the payment provider entity to the payee.

20. (canceled)

21. The method of claim 17, wherein the offering comprises at least one incentive for using a creditor for the payment.

22. The method of claim 17, wherein the offering is based, at least in part, on the payment.
